(19) United States
(12) Patent Application Publication
(10) Pub. No.: US 2026/0248286 A1
(43) Pub. Date: Aug. 27, 2026

(54) STRUCTURE OF CABINET CORNER PLATE

(71) Applicant: GOATER KITCHEN CO., LTD., Taoyuan City (TW)

(72) Inventor: CHENG-HSIN SU, Taoyuan City (TW)

(21) Appl. No.: 19/096,655

(22) Filed: Mar. 31, 2025

(30) Foreign Application Priority Data
Feb. 27, 2025 (TW) 114107491

(51) Int. Cl. A47B 96/20; F16B 12/44

(52) U.S. Cl. CPC A47B 96/20; F16B 12/44

(57) ABSTRACT

A cabinet corner plate includes a first long-side edge portion, an arc curved portion, an inside curved wall portion, an outside curved wall portion, a second long-side edge portion, a mounting portion, a first fixing portion, a second fixing portion, and a first graphics and text portion. The first and second fixing portions on the first and second long-side edge portion are respectively combined with a first and a second wall board, and the first graphics and text portion is set on the outside curved wall portion. Then, a shield plate is mounted to the mounting portion. As such, the inside curved wall portion can be used to carry objects, and the design of outside curved wall portion can prevent users from being hit, and also, the first graphic portion can be used to make the cabinet corner plate consistent with the first and second wall boards.

### BACKGROUND OF THE INVENTION

### Technical Field of the Invention

The present invention relates to a structure of cabinet corner plate that can prevent users from being injured and maintain the overall consistency of construction and appearance.

### Description of the Prior Art

Storage cabinets are the most important storage structure in furniture. There are storage cabinets of styles suitable for placing in either a living room, a bedroom, a kitchen, or even a bathroom. For most of the common storage cabinets available on the market, the cabinet frame is of an assembly structure that uses a right-angled corner. It is not only more convenient to make, but also easier to assemble. It only needs to have two panel vertically fit and fastened together.

In pursuit of both practicality and beauty, a cabinet style with rounded corners has been developed. The rounded corners are not only beautiful, but also safe. The sharp right angles that are easy to scratch and collide are removed and replaced with a smooth and mild rounded corner design. However, the conventional rounded corners are formed by stacking multiple plates and grinding the right angle of the multiple plates into an arc. A complete rounded corner is formed of multiple arcs. This structural arrangement is not only time-consuming and labor-intensive, but also requires the skills of the construction workers.

Although some manufacturers are committed to solving the above problems, other problems arise, such as the lack of any color on the surface, which greatly reduces the visual sense of the interior, lacks overall consistency, and even has inconveniences in construction.

### SUMMARY OF THE INVENTION

The primary objective of the present invention is to make the overall appearance more consistent and more beautiful by means of a design of first graphics and text portion. Through a design of arc curved portion, a user, if accidentally hitting the head against an outside curved wall portion, is not easily injured, and this can better protect the user. Further, through a design of mounting portion, combination with a shield plate can be carried out fast for implementing an operation of closing an accommodation space, saving time and effort. Further, through a design of first fixing portion and second fixing portion, disassembling and assembling with first and second wall boards can be carried out easily and conveniently on site.

The structure that the present invention provides for achieving the aforementioned primary objective comprises a first long-side edge portion, an arc curved portion, an inside curved wall portion, an outside curved wall portion, a second long-side edge portion, a mounting portion, at least one first fixing portion, at least one second fixing portion, and a first graphics and text portion, wherein the arc curved portion is formed by extending from a long-side edge of the first long-side edge portion, and the arc curved portion comprises an inside curved wall portion and an outside curved wall portion, the inside curved wall portion being located at a long-side edge lateral face of the arc curved portion that is different from the first long-side edge portion, an opposite long-side edge lateral face being provided with the outside curved wall portion, and a total surface area of the inside curved wall portion is smaller than a total surface area of the outside curved wall portion, and long-side edge lengths of the inside curved wall portion and the outside curved wall portion are consistent with a long-side edge length of the first long-side edge portion; the second long-side edge portion is formed on a side face of the arc curved portion the first long-side edge portion; the mounting portion is arranged on the inside curved wall portion; the first fixing portion is arranged on the first long-side edge portion for combining with a first wall board; the second fixing portion is arranged on the second long-side edge portion for combining with a second wall board; and finally, the first graphics and text portion is arranged on the outside curved wall portion.

To assemble the cabinet corner plate, the first fixing portion on the first long-side edge portion is first combined with the first wall board, and then, the second fixing portion on the second long-side edge portion is combined the second wall board. Afterwards, a shield plate is mounted to the mounting portion to complete the assembly of the cabinet body. Of course, the first graphics and text portion can be set before the on-site installation or after the on-site installation. As such, the cabinet may form an accommodation space for storage of an object by means of the shield plate, the first wall board, and the second wall board, and the object stored in the accommodation space can still be placed on the second wall board and the inside curved wall portion, and will not be unable to be placed due to the presence of the inside curved wall portion.

By using the above technology, the problems of the prior art technology, such as not colorful, greatly reducing visual sense of interior of a room, lack of overall consistency, and even inconvenience in construction, can be overcome, and the practical progress of the present invention as mentioned above can be achieved.

### BRIEF DESCRIPTION OF THE DRAWINGS

FIG. 1 is a perspective view showing a first preferred embodiment of the present invention.

FIG. 2 is a perspective view showing the first preferred embodiment of the present invention from a different angle.

FIG. 3 is a schematic view illustrating assembling of the first preferred embodiment of the present invention.

FIG. 4 is another schematic view illustrating assembling of the first preferred embodiment of the present invention.

FIG. 5 is a further schematic view illustrating assembling of the first preferred embodiment of the present invention.

FIG. 6 is a schematic view illustrating completion of the first preferred embodiment of the present invention.

FIG. 7 is a schematic view illustrating implementation of the first preferred embodiment of the present invention.

FIG. 8 is a schematic view illustrating combining of a second embodiment of the present invention.

FIG. 9 is a schematic view illustrating implementation of a third preferred embodiment of the present invention.

### DETAILED DESCRIPTION OF THE PREFERRED EMBODIMENTS

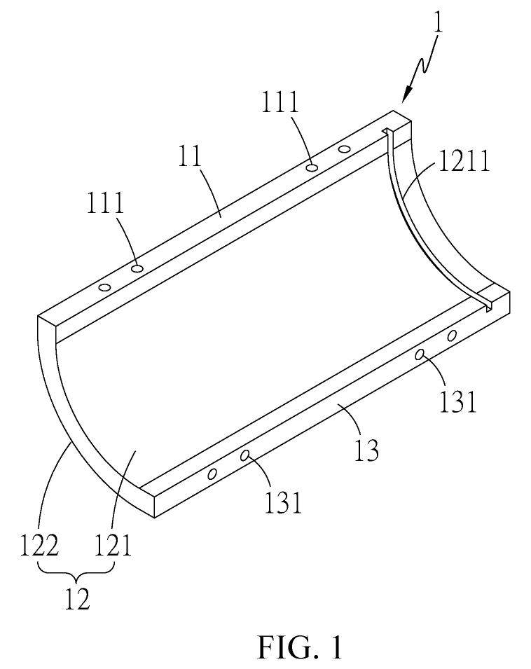

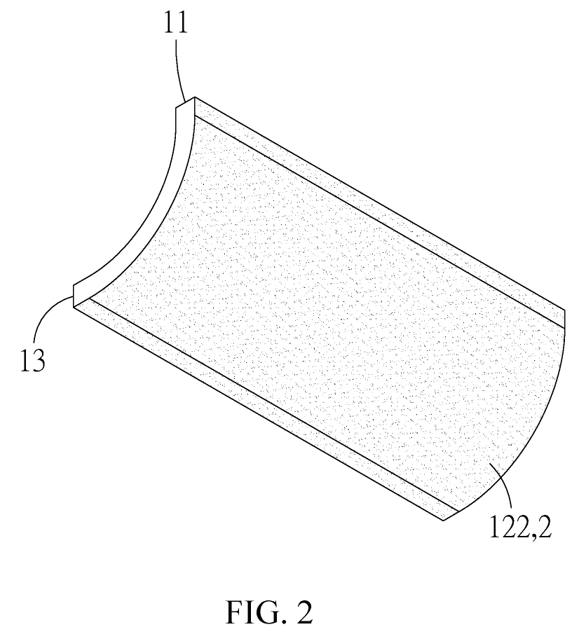

Referring to FIGS. 1 and 2, which are a perspective view of a first preferred embodiment of the present invention and a perspective view taken from a different angle, it is clearly seen from the drawings that a cabinet corner plate 1 according to the present invention comprises:

a first long-side edge portion 11;

an arc curved portion 12, which is formed by extending from a long-side edge of the first long-side edge portion 11, the arc curved portion 12 comprising an inside curved wall portion 121, the inside curved wall portion 121 being located at a long-side edge lateral face of the arc curved portion 12 that is different from the first long-side edge portion 11, an opposite long-side edge lateral face being provided with an outside curved wall portion 122, a total surface area of the inside curved wall portion 121 being smaller than a total surface area of the outside curved wall portion 122, long-side edge lengths of the inside curved wall portion 121 and the outside curved wall portion 122 being consistent with a long-side edge length of the first long-side edge portion;

a second long-side edge portion 13, which is formed on a side face of the arc curved portion 12 away from the first long-side edge portion 11;

a mounting portion 1211, which is arranged on the inside curved wall portion 121;

at least one first fixing portion 111, which is arranged on the first long-side edge portion 11 for combining with a first wall board;

at least one second fixing portion 131, which is arranged on the second long-side edge portion 13 for combining with a second wall board; and

a first graphics and text portion 2, which is arranged on the outside curved wall portion 122.

A curvature of the inside curved wall portion 121 is consistent with a curvature of the outside curved wall portion 122. The mounting portion 1211 is provided in the form of a recessed groove as an example for illustration in the instant embodiment, and a curvature of the mounting portion 1211 is consistent with the curvature of the inside curved wall portion 121. The first graphics and text portion 2 may include at least one of patterns, texts, and graphics, and patterns are taken as an example for illustration in the instant embodiment. In the instant embodiment, the cabinet corner plate 1 is made as a cabinet corner plate 1 for a wall-mounted kitchen cabinet. In the instant embodiment, the first fixing portion 111 and the second fixing portion 131 are holes for joining to the first wall board and the second wall board in a mortise-and-tenon manner, and in the instant embodiment, multiple first fixing portions 111 and multiple second fixing portions 131 are provided as an example for illustration.

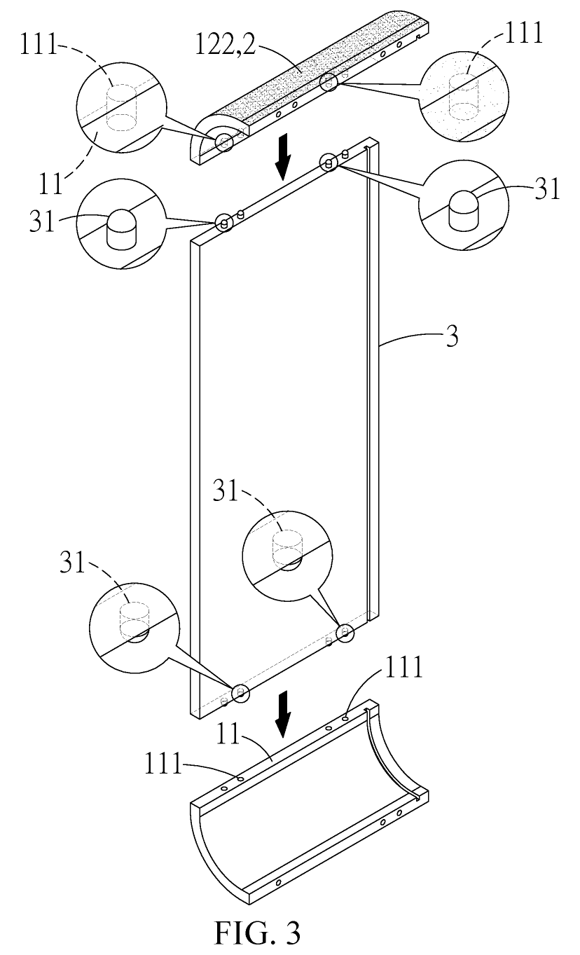

Referring to FIGS. 3-7, which are a schematic view of assembling to a schematic view of implementation of the first preferred embodiment of the present invention, it is clearly seen from the drawings that steps of assembling can be carried out as follows:

(A) firstly, at a factory side, setting the first graphics and text portion 2 on the outside curved wall portion 122, wherein the way of setting is made through spraying or applying a veneer facing material to present the first graphics and text portion 2;

(B) arranging a first wall board 3 to correspond, in position, to the first long-side edge portion 11 and bringing the two close together to have the first fixing portion 111 and the first wall board 3 inserted and combined with each other, wherein the first wall board 3 is provided with a tenon 31 that is joinable to the first fixing portion to have the two smoothly combined and fixed together, see FIG. 3;

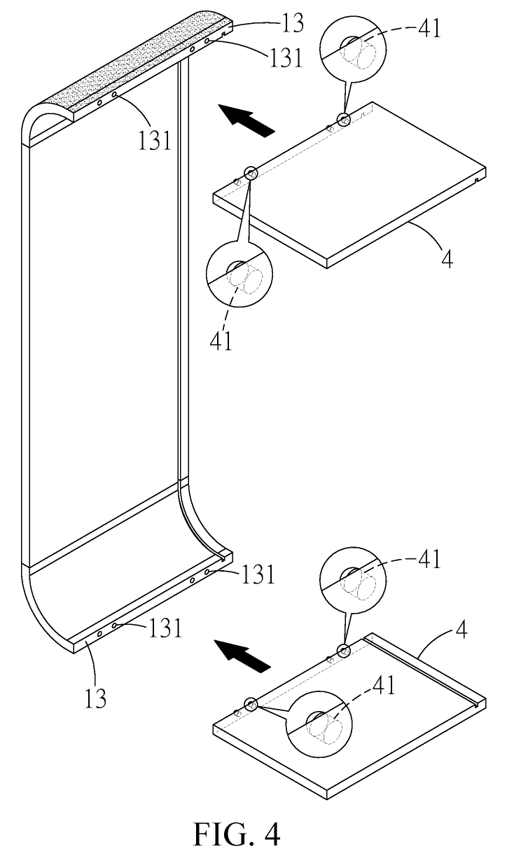

(C) arranging a second wall board 4 to correspond, in position, to the second long-side edge portion 13 and bringing the two close together to have the second fixing portion 131 and the second wall board 4 inserted and combined with each other, wherein the second wall board 4 is provided with a tenon 41 that is joinable to the second fixing portion 131 to have the two smoothly combined and fixed together, see FIG. 4;

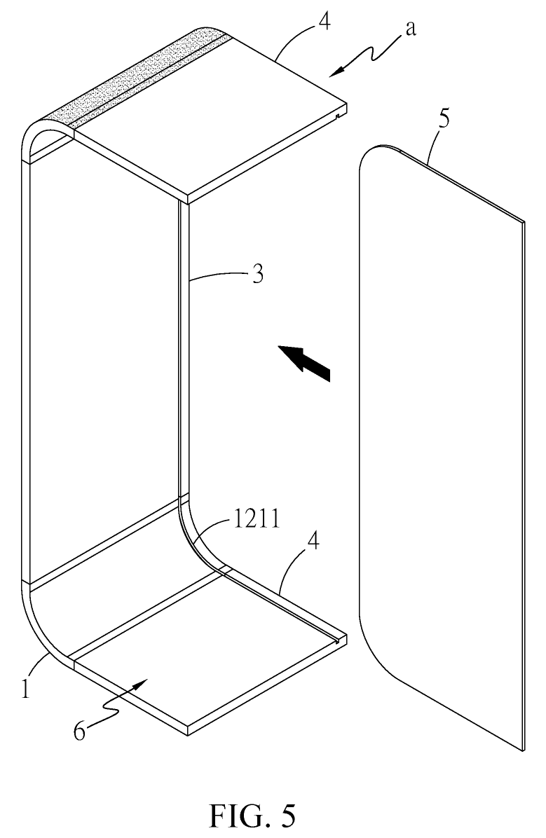

(D) inserting and combining a shield plate 5 with the mounting portion 1211 to complete shielding of a rear side of a cabinet body a and forming an accommodation space 6 for placing an object, wherein the accommodation space 6 is surrounded and delimited by the first wall board 3, the cabinet corner plate 1, the second wall board 4, and the shield plate 5, see FIG. 5; and

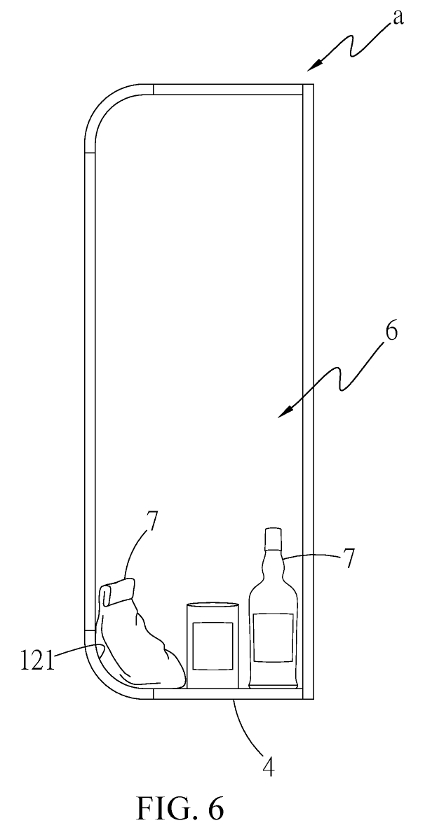

(E) finally, mounting the cabinet body a so completed to a wall of a kitchen to complete the wall-mounted kitchen cabinet, wherein the object 7 placed in the accommodation space 6 can be disposed on the second wall board 4, wherein although the inside curved wall portion 121 is of a curved configuration, an object 7, such as bag-shaped object 7 can still be placed thereon, see FIG. 6.

However, Step (A) can be set before the cabinet body a is assembled or after the cabinet body a has been assembled, and the order of the steps is not limited.

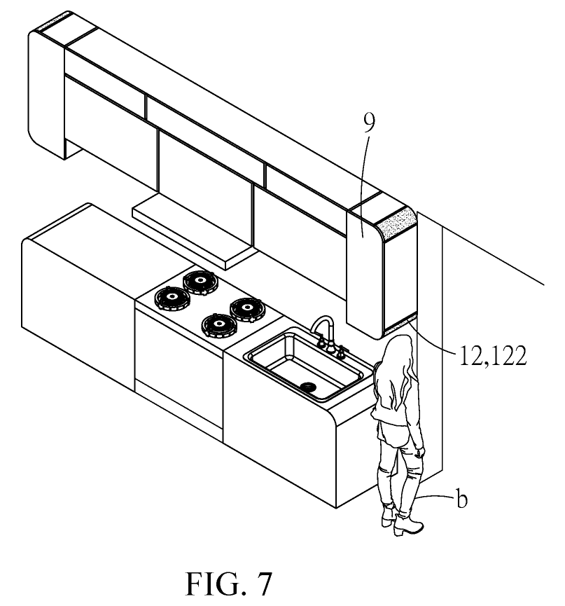

In use, if the head of a user b accidentally hits the outside curved wall portion 122 of the arc curved portion 12, due to the arc curved configuration, the injury to the head is small, and even in the case of a general accidental impact, it will not cause bleeding, and the protect user b can be effectively protected from injury. In addition, due to the material-reduced corner design of the arc curved portion 12, the user b may have more room for movement and is not easy to hit the arc curved portion 12. Further, a door 9 may be additional provided for aesthetic effect, see FIG. 7.

Further, since the cabinet corner plate 1 according to the present invention can be mass-produced by machines, such as plastic molding or 3D printing, to achieve fully automated production, the manufacturing speed can be relatively fast and stable, and labor costs can be saved, increasing industrial competitiveness. In addition, because of the use of machine manufacturing, it can ensure that the thickness, angle, length, width, height and other dimensions of each cabinet corner plate 1are uniform and will not have a huge difference. In addition, the mounting portion 1211, the first fixing portion 111, and the second fixing portion 131 can be more accurately set in position, and the tolerance can be reduced to a minimum level. Installation can be quickly accomplished by workers during construction without repeated reworking.

Further, in case of using the cabinet corner plate 1, as the volume of the cabinet body a is slightly reduced, it can be installed in a kitchen with a relatively crowded indoor space, making it widely applicable and saving space for setting up other objects, such as hangers.

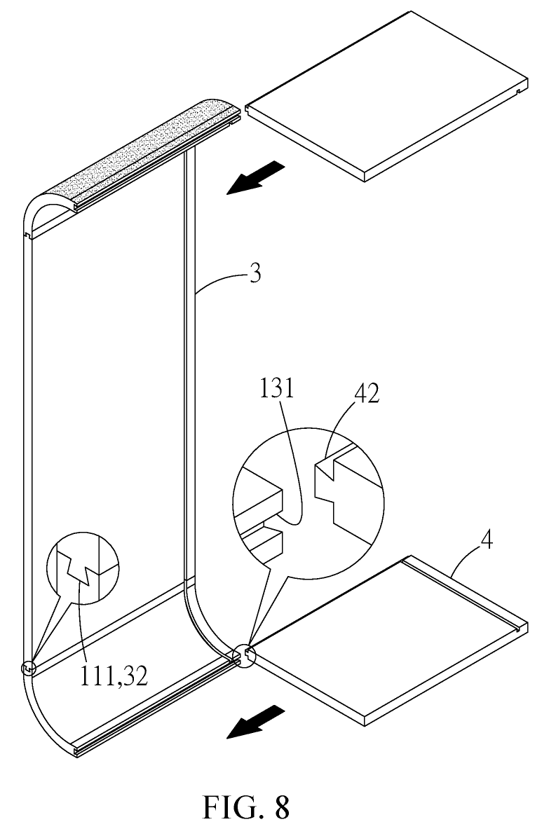

Referring to FIG. 8, which is a schematic view illustrating combining of a second embodiment of the present invention, it is clearly seen from the drawing that the instant embodiment is different from the previous embodiment in that in the instant embodiment, the first fixing portion 111 and the second fixing portion 131 are made as mortise grooves to combine with the first wall board 3 and the second wall board 4 in a fitting manner. The first wall board 3 and the second wall board 4 are provided with tenon blocks 32, 42 fit to and mutually engageable with the first fixing portion 111 and the second fixing portion 131. Further, gluing may be applied in the process of combination to enhance the fixing effect. Applying the fitting manner for combination can have a faster combination speed and a more stable combination.

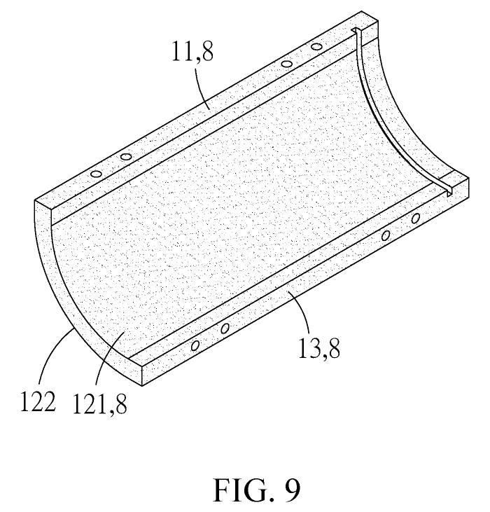

Referring to FIG. 9, which is a schematic view illustrating implementation of a third preferred embodiment of the present invention, it is clearly seen from the drawing that the instant embodiment is different from the first preferred embodiment in that in the instant embodiment, in addition to the outside curved wall portion 122 being provided with the first graphics and text portion, a second graphics and text portion 8 is further provided on the first long-side edge portion 11, the inside curved wall portion 121, the second long-side edge portion 13, and a short-side edge lateral face of the arc curved portion 12, and the second graphics and text portion 8 may include at least one of patterns, texts, and graphics. In the instant embodiment, patterns are taken as an example for illustration. As such, all the surfaces of the cabinet corner plate 1 are provided with pattern colors, making the cabinet body consistent in both inside and outside and more visually comfortable.

I claim:

1. A structure of cabinet corner plate, the cabinet corner plate comprising:
a first long-side edge portion;
an arc curved portion, which is formed by extending from a long-side edge of the first long-side edge portion, the arc curved portion comprising an inside curved wall portion, the inside curved wall portion being located at a long-side edge lateral face of the arc curved portion that is different from the first long-side edge portion, an opposite long-side edge lateral face being provided with an outside curved wall portion, a total surface area of the inside curved wall portion being smaller than a total surface area of the outside curved wall portion, long-side edge lengths of the inside curved wall portion and the outside curved wall portion being consistent with a long-side edge length of the first long-side edge portion;
a second long-side edge portion, which is formed on a side face of the arc curved portion away from the first long-side edge portion;
a mounting portion, which is arranged on the inside curved wall portion;
at least one first fixing portion, which is arranged on the first long-side edge portion for combining with a first wall board;
at least one second fixing portion, which is arranged on the second long-side edge portion for combining with a second wall board; and
a first graphics and text portion, which is arranged on the outside curved wall portion and a short-side edge lateral face of the arc curved portion.

2. The structure of cabinet corner plate according to claim 1, wherein a curvature of the inside curved wall portion is consistent with a curvature of the outside curved wall portion.

3. The structure of cabinet corner plate according to claim 1, wherein the first fixing portion and the second fixing portion are holes for joining to the first wall board and the second wall board in a mortise-and-tenon manner.

4. The structure of cabinet corner plate according to claim 1, wherein the first fixing portion and the second fixing portion are mortise grooves for joining the first wall board and the second wall board in a fitting manner.

5. The structure of cabinet corner plate according to claim 1, wherein a curvature of the mounting portion is consistent with a curvature of the inside curved wall portion.

6. The structure of cabinet corner plate according to claim 1, wherein a second graphics and text portion is provided on the first long-side edge portion, the inside curved wall portion, the second long-side edge portion, and the short-side edge lateral face of the arc curved portion.

7. The structure of cabinet corner plate according to claim 6, wherein the first graphics and text portion and the second graphics and text portion comprises at least one of patterns, texts, and graphics.

8. The structure of cabinet corner plate according to claim 1, wherein the cabinet corner plate is a cabinet corner plate of a wall-mounted kitchen cabinet.
